(19) United States
(12) Patent Application Publication
(10) Pub. No.: US 2006/0228188 A1
(43) Pub. Date: Oct. 12, 2006

(54) Self-drilling wall anchor device and method for using the same

(75) Inventors: Chin-Jen Hsu, Taichung (TW); Ming-Chia Cheng, Taichung (TW); Chien-Ming Lu, Taichung (TW)

Correspondence Address: CHARLES E. BAXLEY, ESQ., 90 JOHN STREET, THIRD FLOOR, NEW YORK, NY, 10038, US

(73) Assignee: Alliance Metal Corporation

(21) Appl. No.: 11/448,325

(22) Filed: Jun. 7, 2006

Related U.S. Application Data
(63) Continuation-in-part of application No. 10/950,742, filed on Sep. 27, 2004.

(51) Int. Cl. F16B 13/04

(52) U.S. Cl. 411/29

(57) ABSTRACT

A self-drilling wall anchor device has a central bolt, an outer sleeve and a drilling head. The central bolt has a bolt body, a head and a connection portion. The bolt body has a first thread formed around the bolt body. The outer sleeve is mounted around the bolt body of the central bolt and has a flange, a second thread, a compressed head and a deformable portion. The flange is radially formed on and extends from the proximal end of the outer sleeve. The second thread is formed around the outer sleeve near the flange. The compressed head is formed on the distal end of the outer sleeve and has a through hole. The through hole is defined through the compressed head and has a diameter larger than that of the connection portion and smaller than that of the first thread.

The present invention is a continuation-in-part application of application Ser. No. 10/950,742, filed on Sep. 27, 2004.

### BACKGROUND OF THE INVENTION

1. Field of the Invention

The present invention relates to a wall anchor device, and more particularly to a wall anchor device that can be securely attached to a wall in a single rotation process.

2. Description of Related Art

To hand an object on a wall, such as a plaster of Paris cast or a plastic, wooden or concrete wall, a nail is hammered into the wall for supporting the object. However, the weight of the hung object will apply a large torque to the inserted portion of the nail to cause the hole in the wall for holding the nail to be enlarged. Thus, the nail with the object easily falls from the wall, and the nail cannot support a heavy load.

To solve the aforementioned problem, an expansion bolt is provided and substantially comprises a bolt and a plastic sleeve. To attach the expansion bolt to a wall, a hole is drilled in the wall with a drilling device firstly. The plastic sleeve is put into the hole, and the bolt is screwed into the sleeve to deform and expand the sleeve. With the deformation of the sleeve, the expanded sleeve will engage with the inner surface of the hole and securely hold the nail in the sleeve. Accordingly, the bolt can support an object with a heavy weight.

However, to attach the conventional expansion bolt to a wall is laborious and time-consuming. Therefore, a wall anchor, such as U.S. Pat. No. 5,147,166 entitled to “Wall Anchor” is provided to attach the wall anchor to a wall in a single operation process. The '166 Patent substantially comprises an actuating element 70, a body element 22, a nut element 50 and a penetration element 60. The body element 22 is fabricated from cold rolled steel sheet and comprises at least one anchor head 24, two deformable legs 26, two inner toggle arms 38 and two outer toggle arms 40. The inner and outer toggle arms 38,40 are provided with openings 46. The deformable legs 26 extend toward the nut element 50 to curve the toggle arms 38,40 and align the openings 46.

The nut element 50 is made of metal and comprises two projections 52 and two extending arms 54. With the engagements of the projections 52 and the openings 46, the extension arms 54 extend toward the penetration element 60.

In operation, the actuating element 70 is rotated and drills a hole in a wall by the penetration element 60. The body element 22 extends and moves into the hole with the rotation of the actuating element 70 until the anchor head 24 abuts with the wall. When the actuating element 70 is kept rotated, the nut element 50 is moved toward the anchor head 24 of the body element 22 to curve the deformable legs 26 to abut against the wall, such that the body element is kept from escaping from the hole in the wall. However, the wall anchor of the '166 Patent has shortcomings as follows:

1. The wall anchor of the '166 Patent comprises an actuating element, a body element, a nut element and a penetration element and is complex in structure.

2. The body element and nut element must be bent for assembling with the actuating element and the penetration element, so to assemble the wall anchor of the '166 Patent is difficult and trouble.

3. Because the wall anchor of the '166 Patent has a complex structure and is difficult in assembling, the cost for manufacturing the wall anchor is high.

To overcome the shortcomings, the present invention tends to provide a wall anchor to mitigate or obviate the aforementioned problems.

### SUMMARY OF THE INVENTION

The main objective of the invention is to provide a self-drilling wall anchor device that can be securely attached to a wall in a single rotation process and is convenient in use and assembling. The self-drilling wall anchor device has a central bolt, an outer sleeve and a drilling head. The central bolt has a bolt body, a head and a connection portion. The bolt body has a proximal end, a distal end and a first thread formed around the bolt body and having a diameter. The head is formed on the proximal end of the bolt body. The connection portion is formed on the distal end of the bolt body and has a diameter. The outer sleeve is mounted around the bolt body of the central bolt and has an outer diameter, a proximal end, a distal end, a flange, a second thread, a compressed head and a deformable portion. The flange is radially formed on and extends from the proximal end of the outer sleeve. The second thread is formed around the outer sleeve near the flange. The compressed head is formed on the distal end of the outer sleeve and has a proximal end, a distal end and a through hole. The proximal end is formed on the distal end of the outer sleeve. The through hole is defined through the compressed head and has a diameter larger than that of the connection portion of the central bolt and smaller than that of the first thread on the central bolt. The deformable portion is mounted between the compressed head and the second thread and has multiple slots longitudinally defined in the deformable portion. The drilling head is attached to and rotated with the connection portion of the central bolt and has multiple blades having a diameter larger than the outer diameter of the outer sleeve.

Other objects, advantages and novel features of the invention will become more apparent from the following detailed description when taken in conjunction with the accompanying drawings.

### BRIEF DESCRIPTION OF THE DRAWINGS

FIG. 1 is a side plan view of a self-drilling wall anchor in accordance with the present invention;

FIG. 2 is a side plan view in partial section of the wall anchor in FIG. 1;

FIG. 3 is an enlarged perspective view in partial section of the wall anchor in FIG. 1;

FIG. 4 is an enlarged cross sectional side plan view of the compressed head of the wall anchor in FIG. 1;

FIG. 5 is operational side plan views in partial section of the wall anchor in FIG. 1 showing the process of attaching the wall anchor to a wall;

FIG. 6 is operational side plan views in partial section of the wall anchor in FIG. 1 showing that the central bolt is detached from the deformed outer sleeve;

FIG. 7 is a perspective view of a first operational embodiment of a self-drilling wall anchor in accordance with the present invention;

FIG. 8 is an exploded perspective view of a second operational embodiment of a self-drilling wall anchor in accordance with the present invention;

FIG. 9 is a perspective view of a third operational embodiment of a self-drilling wall anchor in accordance with the present invention; and

FIG. 10 is a perspective view of another embodiment of a self-drilling wall anchor in accordance with the present invention.

### DETAILED DESCRIPTION OF PREFERRED EMBODIMENT

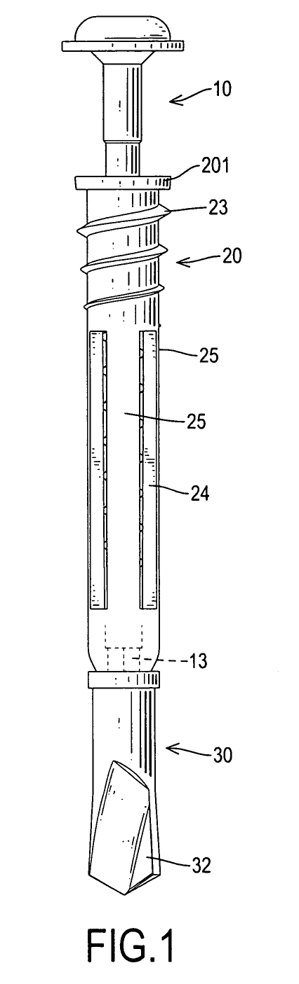

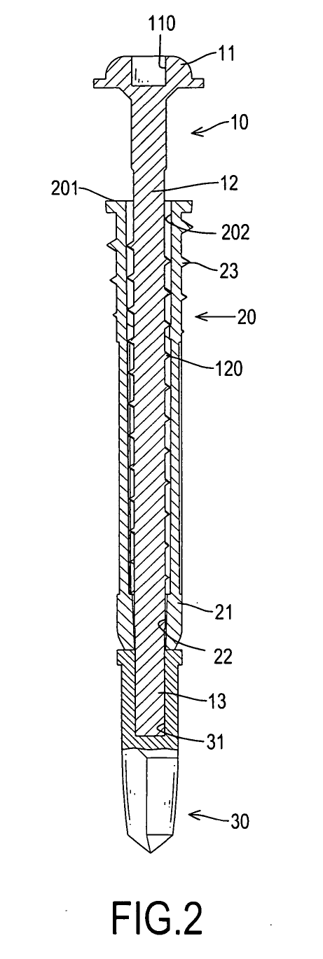

With reference to FIGS. 1 and 2, a self-drilling wall anchor device in accordance with the present invention comprising a central bolt (10), an outer sleeve (20) and a drilling head (30). The central bolt (10) comprises a bolt body (12), a head (11) and a connection portion (13). The bolt body (12) has a proximal end, a distal end and a first thread (120) formed around the bolt body (12) and having a diameter. The first thread (120) may be a self-drilling thread and has a diameter gradually enlarged from the distal end to the proximal end of the central bolt (12). The head (11) is formed on the proximal end of the bolt body (12) and has a tool recess (110) defined in the head (11). The tool recess (110) may be square, hexagonal or crisscross to fit with different tools. In an alternative embodiment, the head (11) may have a hexagonal cross section for fitting with a tool sleeve. The connection portion (13) is formed on the distal end of the bolt body (13) and has a diameter.

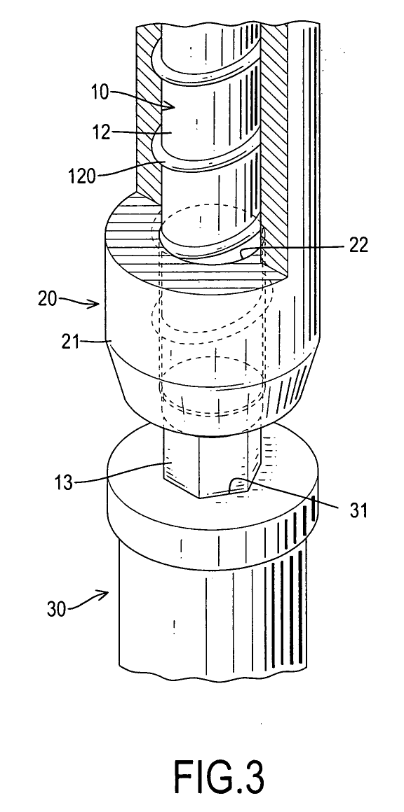

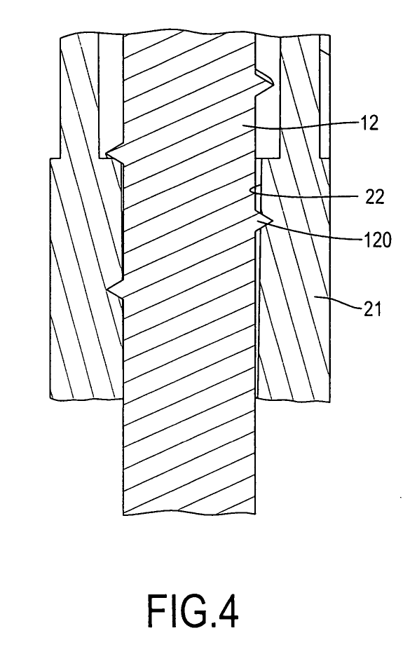

With further reference to FIGS. 3 and 4, the outer sleeve (20) is made of plastic material and is mounted around the bolt body (12) of the central bolt (10). The outer sleeve (20) has a diameter, a proximal end, a distal end, a central hole (202), a flange (201), a second thread (23), a compressed head (21) and a deformable portion (25). The central hole (202) is defined through the outer sleeve (20) and has a diameter larger than that of the first thread (120) on the central bolt (10) to hold the bolt body (12) inside. The flange (201) is radially formed on and extends from the proximal end of the outer sleeve (20). The second thread (23) is formed around the outer sleeve (20) near the flange (201). The second thread (23) has a diameter gradually decreased from an end near the flange (201) to the other end to form as a self-drilling thread. The compressed head (21) is formed on the distal end of the outer sleeve (20) and has a proximal end, a distal end and a through hole (22). The proximal end is formed on the distal end of the outer sleeve (20). The through hole (22) is defined through the compressed head (21) and communicates with the central hole (202) of the outer sleeve (20). The through hole (22) has a diameter larger than that of the connection portion (13) of the central bolt (10) and smaller than that of the first thread (120) on the central bolt (10). In a preferred embodiment, the through hole (22) is conical and the diameter of the through hole (22) is gradually decreased from the proximal end to the distal end of the compressed head (21). The largest diameter of the through hole (22) is smaller than that of the first thread (120) on the central bolt (10).

The deformable portion (25) is mounted between the compressed head (21) and the second thread (23) and has multiple slots (24) longitudinally defined in the deformable portion (25) to make the deformable portion (25) be resilient for deformation.

The drilling head (30) is attached to and rotated with the connection portion (13) of the central bolt (10). The drilling head (30) and the connection portion (13) of the central bolt (10) are combined with each other in a hexagonal manner. In other words, a hexagonal cavity (31) is defined in the drilling head (30), and an extension with a hexagonal cross section is formed on the connection portion (13) and extends into and engages with the hexagonal cavity (31) in the drilling head (30). With the engagement of the cavity (31) and the extension, the drilling head (30) is detachably connected and rotated with the central bolt (10). The drilling head (30) has multiple blades (32) having a diameter larger than the outer diameter of the outer sleeve (20).

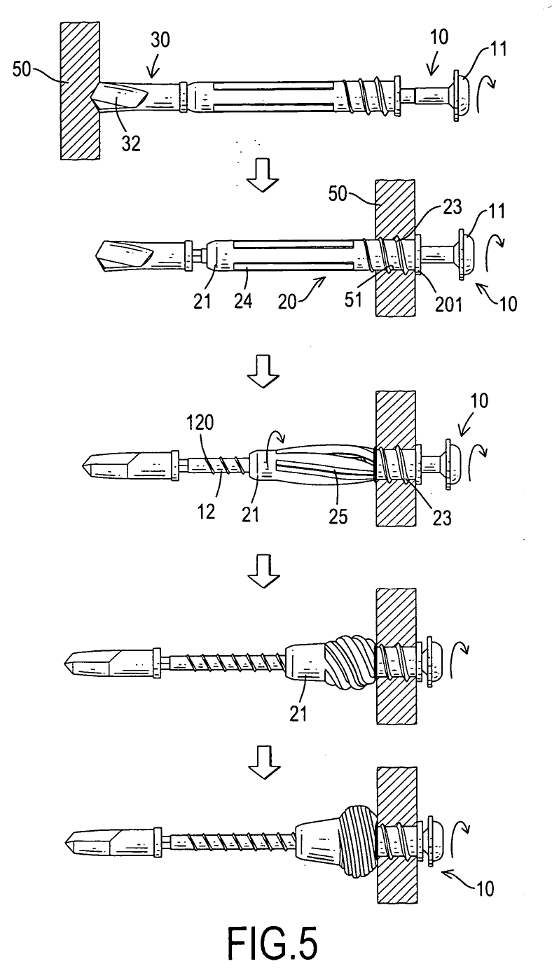

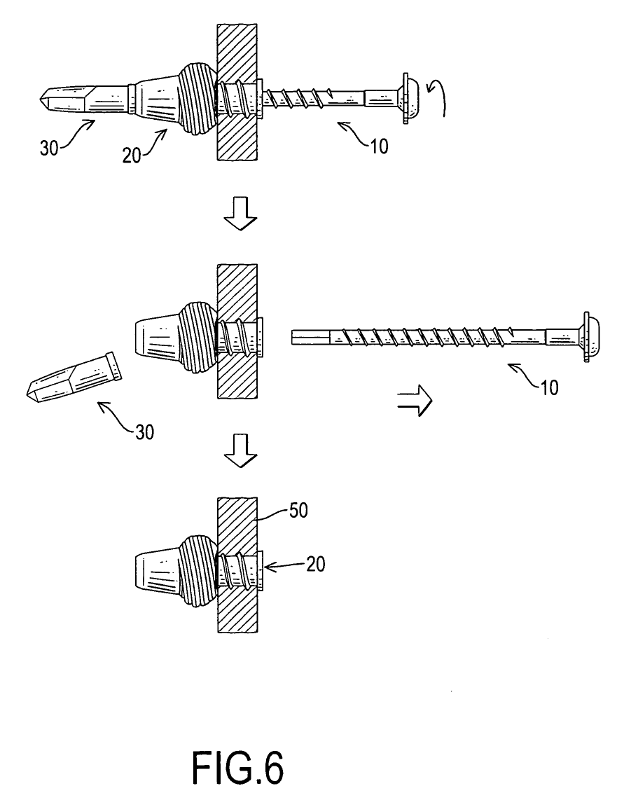

With reference to FIGS. 2, 5 and 6, before the wall anchor is attached to a wall (50), the first thread (120) is kept from screwing into the through hole (22) in the compressed head (21) of the outer sleeve (20), so that the central bolt (10) can be rotated relative to the outer sleeve (20). In use, a tool, such as an electrical or pneumatic tool is complied with the head (11) to drive the central bolt (10) to rotate, such that a hole (51) is defined in a wall (50) by the blades (32) on the drilling head (30) rotated with the central bolt (10). When the central bolt (10) is rotated, the first thread (120) on the central bolt (10) will be screwed into and engage with the through hole (22) in the compressed head (21) of the outer sleeve (20) to make the outer sleeve (20) to rotate with the central bolt (10). Because the largest diameter of the through hole (22) in the compressed head (21) is smaller than that of the first thread (120), the engagement between the first thread (120) and the through hole (22) is secure and high.

With the rotation of the outer sleeve (20) with the central bolt (10), the second thread (23) on the outer sleeve (20) will be screwed into the hole (51). When the flange (201) abuts with the wall (50), the rotation of the outer sleeve (20) will be stopped. Consequently, the compressed head (21) will be moved along the central bolt (10) by the first thread (120) screwing through the through hole (22) in the compressed head (21) during the period of rotating the central bolt (10). Accordingly, the deformable portion (25) of the outer sleeve (20) is deformed and expanded. With the expanded deformable portion (25) abutting with the wall (50) or engaging with the hole (51) in the wall (50), the outer sleeve (20) is securely attached to the wall (50) and is kept from escaping from the hole (51). Thus, the central bolt (10) can hang an object directly and bear a large load.

If the central bolt (10) is rotated in reverse, the drilling head (30) will be detached from the connection portion (13) of the central bolt (10) when the drilling head (30) abuts with the compressed head (21) and the central bolt (10) can be detached from the outer sleeve (20). Consequently, a hanger can be inserted into the outer sleeve (20) for hanging an object.

In such an arrangement, the wall anchor can be securely attached to the wall (50) in a single rotation process, to use the wall anchor is convenient and easy. In addition, the structure of the wall anchor in accordance with the present invention is simplified and is easy to assemble and manufacture, the cost for manufacturing the wall anchor is reduced.

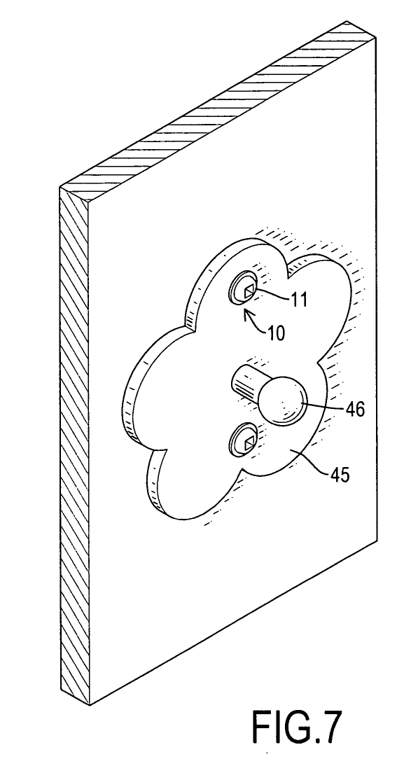

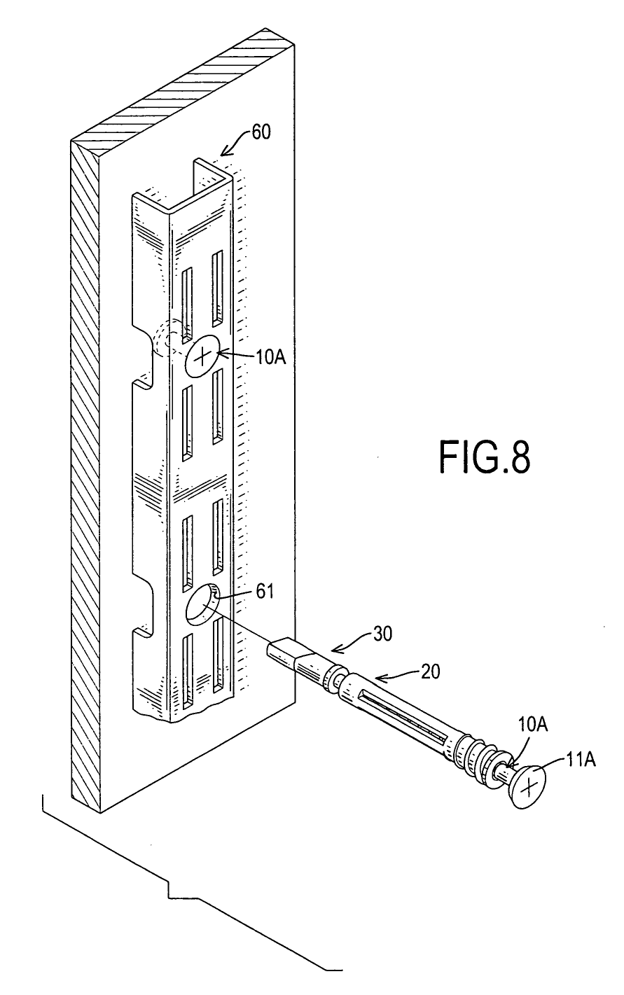

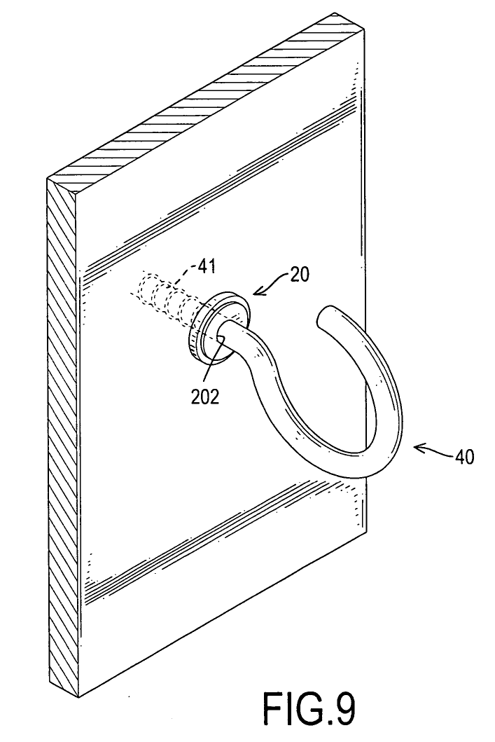

With reference to FIG. 7, two wall anchors are attached to a wall to support a hanging board (45) with a hook (46) for hanging an object. With reference to FIG. 8, multiple wall anchors are attached to a wall to support a frame (60) with holes (61) through which the wall anchors extends, such that multiple frames (60) can compose of a rack to support objects in cooperation with boards. With reference to FIG. 9, a hook (40) with a screw (41) can be screwed into the central hole (202) in the deformed outer sleeve (20) for hanging an object.

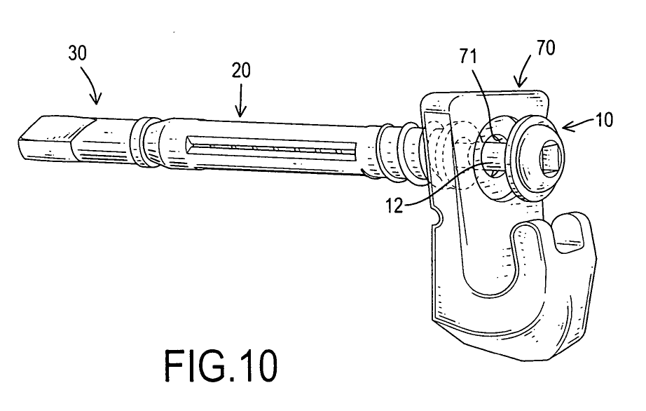

With reference to FIG. 10, a hanging element (70) with a bore (71) is optionally mounted around the bolt body (12) of the central bolt (10), such that an object can be hung on the hanging element (70) when the wall anchor is attached to a wall.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A self-drilling wall anchor device comprising:
a central bolt comprising
a bolt body having a proximal end, a distal end and a first thread formed around the bolt body and having a diameter,
a head formed on the proximal end of the bolt body; and
a connection portion formed on the distal end of the bolt body and having a diameter;
an outer sleeve mounted around the bolt body of the central bolt and comprising
an outer diameter;
a proximal end;
a distal end;
a flange radially formed on and extending from the proximal end of the outer sleeve;
a second thread formed around the outer sleeve near the flange;
a compressed head formed on the distal end of the outer sleeve and having
a proximal end formed on the distal end of the outer sleeve;
a distal end; and
a through hole defined through the compressed head and having a diameter larger than that of the connection portion of the central bolt and smaller than that of the first thread on the central bolt; and
a deformable portion mounted between the compressed head and the second thread and having multiple slots longitudinally defined in the deformable portion; and
a drilling head attached to and rotated with the connection portion of the central bolt and having multiple blades having a diameter larger than the outer diameter of the outer sleeve.

2. The wall anchor device as claimed in claim 1, wherein the drilling head and the connection portion of the central bolt are combined with each other in a hexagonal manner.

3. The wall anchor device as claimed in claim 2, wherein the first thread on the central bolt is a self-drilling thread.

4. The wall anchor device as claimed in claim 1, wherein the first thread on the central bolt is a self-drilling thread.

5. The wall anchor device as claimed in claim 4, wherein the through hole in the compressed head of the outer sleeve is conical and the diameter of the through hole is gradually decreased from the proximal end to the distal end of the compressed head.

6. The wall anchor device as claimed in claim 3, wherein the through hole in the compressed head of the outer sleeve is conical and the diameter of the through hole is gradually decreased from the proximal end to the distal end of the compressed head.

7. The wall anchor device as claimed in claim 2, wherein the through hole in the compressed head of the outer sleeve is conical and the diameter of the through hole is gradually decreased from the proximal end to the distal end of the compressed head.

8. The wall anchor device as claimed in claim 1, wherein the through hole in the compressed head of the outer sleeve is conical and the diameter of the through hole is gradually decreased from the proximal end to the distal end of the compressed head.

9. A method of using a self-drilling wall anchor device comprising
a central bolt comprising
a bolt body having a proximal end, a distal end and a first thread formed around the bolt body and having a diameter,
a head formed on the proximal end of the bolt body; and
a connection portion formed on the distal end of the bolt body and having a diameter;
an outer sleeve mounted around the bolt body of the central bolt and comprising
an outer diameter;
a proximal end;
a distal end;
a flange radially formed on and extending from the proximal end of the outer sleeve;
a second thread formed around the outer sleeve near the flange;
a compressed head formed on the distal end of the outer sleeve and having
a proximal end formed on the distal end of the outer sleeve;
a distal end; and
a through hole defined through the compressed head and having a diameter larger than that of the connection portion of the central bolt and smaller than that of the first thread on the central bolt; and
a deformable portion mounted between the compressed head and the second thread and having multiple slots longitudinally defined in the deformable portion; and
a drilling head attached to and rotated with the connection portion of the central bolt and having multiple blades having a diameter larger than the outer diameter of the outer sleeve, and
the method comprising acts of:
rotating the central bolt to drill a hole in a wall by the drilling head;
screwing the first thread on the central bolt into the through hole in the compressed head of the outer sleeve during a period of rotating the central bolt to make the outer sleeve to rotate with the central bolt;
screwing the outer sleeve into the hole with the second thread on the outer sleeve during the period of rotating the central bolt;
stopping the rotation of the outer sleeve by abutting the flange on the wall during the period of rotating the central bolt; and
moving the compressed head along the central bolt by the first thread screwing through the through hole in the compressed head during the period of rotating the central bolt to expand the deformable portion of the outer sleeve.
